(19) United States
(12) Patent Application Publication
(10) Pub. No.: US 2026/0113292 A1
(43) Pub. Date: Apr. 23, 2026

(54) AUDIO-BASED ELECTRONIC MESSAGE MANAGEMENT USING A VIRTUAL ASSISTANT

(71) Applicant: Google LLC, Mountain View, CA (US)

(72) Inventors: Kathleen Alexandra Bryan, New York, NY (US); Shiblee Imtiaz Hasan, Santa Clara, CA (US)

(21) Appl. No.: 18/921,673

(22) Filed: Oct. 21, 2024

(51) Int. Cl. H04L 51/216; G06F 40/30; G10L 13/04; G10L 13/08; G10L 15/22

(52) U.S. Cl. CPC H04L 51/216; G06F 40/30; G10L 13/04; G10L 13/08; G10L 15/22

(57) ABSTRACT

Methods and systems for audio-based electronic message management using a virtual assistant are provided. Summarization data pertaining to content of one or more electronic messages associated with a first user of a platform is obtained. A first audio signal reflecting the obtained summarization data is provided for presentation to the first user via a client device associated with the first user. A second audio signal including a verbal response provided by the first user to the one or more electronic messages via the client device is received. An additional electronic message including a textual response to the one or more electronic messages is generated based on the verbal response of the second audio signal. The additional electronic message is transmitted for presentation to one or more second users of the platform.

### TECHNICAL FIELD

Aspects and implementations of the present disclosure relate to audio-based electronic message management using a virtual assistant.

### BACKGROUND

A platform can provide users with access to an electronic communication service, such as an electronic mail (e-mail) service, that enables users to correspond with other users of the platform and/or non-users of the platform. In some instances, the platform can provide users with access to multiple types of electronic communication services (e.g., e-mail communication, chat message communication, etc.) that enable users to communicate via different communication mediums. It can be difficult and time consuming for a user to access and respond to each message received via each communication medium.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes obtaining summarization data pertaining to content of one or more electronic messages associated with a first user of a platform. The method further includes providing a first audio signal reflecting the obtained summarization data for presentation to the first user via a client device associated with the first user. The method further includes receiving a second audio signal including a verbal response provided by the first user to the one or more electronic messages via the client device. The method further includes generating, based on the verbal response of the second audio signal, an additional electronic message including a textual response to the one or more electronic messages. The method further includes transmitting the additional electronic message for presentation to one or more second users of the platform.

In some implementations, obtaining the summarization data includes providing, as an input to an AI model trained to perform a set of tasks pertaining to electronic documents of the platform, the one or more electronic messages and a prompt instructing the AI model to generate the summarization data based on the content of the one or more electronic messages. The method further includes obtaining one or more outputs of the AI model, the one or more outputs including the summarization data.

In some implementations, generating the additional electronic message including the textual response includes providing, as an additional input to the AI model, audio data associated with the second audio signal and an additional prompt instructing the AI model to generate the additional electronic message including the textual response to the one or more electronic messages. The method further includes obtaining one or more additional outputs of the AI model, the one or more additional outputs including the generated additional electronic message.

In some implementations, the audio data includes at least one of the second audio signal or textual data representing the verbal response of the second audio signal.

In some implementations, at least one of the prompt or the additional prompt further comprise additional data associated with at least one of the first user or the one or more second users, wherein the additional data includes at least one of: one or more calendar entries of a calendar associated with the at least one of the first user or the one or more second users, an indication of one or more electronic documents associated with the at least one of the first user or the one or more second users, an indication of one or more prior electronic messages between the first user and the one or more second users, an indication of one or more prior electronic messages between the first user and one or more third users of the platform, or an indication of one or more user preferences associated with the first user.

In some implementations, the method further includes identifying a first electronic message directed to the first user of the platform from the one or more second users. The method further includes determining that content of the first electronic message is associated with content of a second electronic message directed to the first user of the platform from the one or more second users. The summarization data pertains to the content of the first electronic message and the second electronic message.

In some implementations, the one or more electronic messages include at least one of: an electronic mail (e-mail) message, a chat message, or a comment associated with one or more electronic documents.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example platform, an example artificial intelligence (AI) engine and an example virtual assistant, in accordance with implementations of the present disclosure.

FIG. 3 depicts a flow diagram of an example method for audio-based electronic message management, in accordance with implementations of the present disclosure.

FIGS. 4A-4B illustrate examples of audio-based electronic message management using a virtual assistant, in accordance with implementations of the present disclosure.

FIG. 5 illustrates another example of audio-based electronic message management using a virtual assistant, in accordance with implementations of the present disclosure.

FIG. 6 depicts a block diagram of an example predictive system, in accordance with implementations of the present disclosure.

FIG. 7 is a block diagram illustrating an exemplary computer system, in accordance with implementations of the present disclosure.

### DETAILED DESCRIPTION

Aspects of the present disclosure generally relate to electronic message management. A user of an electronic mail (e-mail) communication service can receive a significant number (e.g., hundreds, thousands, etc.) of e-mail messages per day. It can take a significant amount of time for a user to review, and in some instances respond to, each message in the user's inbox. In some instances, important messages may be buried in a user's inbox amongst non-important messages, and therefore important information can be easily overlooked by the user. This can result in missed deadlines, decreased productivity, and miscommunication, amongst other consequences.

In addition to the above-described challenges, an overflowing inbox can impact the overall performance of a system that hosts or otherwise supports the e-mail communication service. For example, a user's account may be associated with hundreds or thousands of unread e-mail messages, which may consume a large amount of memory space of a client device that stores the e-mail messages and/or computing devices of the e-mail communication service that provide the user with access to the e-mail messages (e.g., until the user reviews and/or deletes the messages from their inbox). Some messages may also include or be associated with other electronic documents (e.g., attachments), which can further increase the amount of memory space consumed to store a user's messages. As indicated above, storing a large volume of e-mail messages can consume a large amount of memory space of a computing system and, in some instances, can also consume a large amount of processing resources (e.g., processing cycles). These computing resources are therefore unavailable for other processes of the system, which can increase the overall latency and decrease the overall efficiency of the system.

Further, some platforms enable users to communicate with other users using multiple different communication mediums and/or channels. For example, a platform may provide users with access to an e-mail communication service (e.g., which enables users to communicate via e-mail), a chat messaging service (e.g., which enables users to communicate via chat messages using one or more applications of the platform), a collaborative document service (e.g., which enables users to collaborate and/or communicate on electronic documents) and so forth. A user of such platform may receive multiple messages via the chat messaging service and/or the collaborative document service (e.g., if another user adds a comment to a document directed to the user) throughout the day, in addition to e-mail messages described above. Such additional messages received via the additional communication mediums and/or channels can exacerbate the above described challenges.

Embodiments of the present disclosure address the above and other deficiencies by providing techniques for audio-based electronic message management using a virtual assistant. In some embodiments, a user of a platform can provide a request (e.g., via a client device of the user) for a virtual assistant of the platform to provide the user with an audio-based summarization of one or more electronic messages directed to the user. The electronic messages can include e-mail messages, chat messages, comments of an electronic document associated with the user, and so forth. In one illustrative example, the user can provide a request to initiate an inbox summarization session, which involves the virtual assistant providing the user with a summarization of each electronic message that has not been accessed (e.g., has not been opened and/or read) by the user (e.g., via corresponding applications of the platform). Upon receiving the request, the platform can obtain summarization data pertaining to content of one or more electronic messages directed to the user. In some embodiments, the platform can parse one or more inboxes (e.g., e-mail inboxes, chat message inboxes, etc.) and/or a comment queue (e.g., including comments of electronic documents directed to the user) associated with the user and can identify one or more electronic messages that have not yet been accessed by the user. Upon identifying such electronic messages, the platform can obtain summarization data for one or more of the electronic messages, as described below.

In some embodiments, the platform can determine that content of an electronic message (e.g., of a particular inbox or comment queue) is related to content of another electronic message (e.g., of the same inbox or comment queue or of a different inbox or comment queue). In a first illustrative example, the platform can determine that content of a first electronic message indicates a date and time for a meeting to discuss a particular topic and content of a second electronic message indicates an agenda or outline for the meeting. In a second illustrative example, the platform can determine that content of a first electronic message includes a question (e.g., from a user of the platform) of when a meeting is taking place and that content of a second electronic message includes a response to the question (e.g., from an additional user of the platform) of the date and time for the meeting. In accordance with the first and second illustrative examples, upon determining that the contents of electronic messages are related, the platform can obtain the summarization data based on both the first electronic message and the second electronic message, as described below.

In some embodiments, the platform can obtain summarization data pertaining to the content of the one or more electronic messages by providing the one or more electronic messages as an input to an AI model that is trained to perform content summarization tasks based on given content. In some embodiments, the AI model can be a general-purpose large language model (LLM) that is trained to perform multiple different tasks (e.g., including content summarization tasks) based on a given input. In other or similar embodiments, the AI model can be a specific-purpose LLM that is trained to perform content summarization tasks only. The platform can provide the content as an input to the AI model and can obtain one or more outputs of the AI model, which can include the summarization data. The summarization data can include a summary of the content of the one or more electronic messages. In accordance with the first illustrative example, the summarization data can indicate the date and time for the meeting and a summary of the agenda or outline for the meeting. In accordance with the second illustrative example, the summarization data can include an indication of the question of the user and an indication of the response to the question by the additional user.

Upon obtaining the summarization data, the platform can generate an audio signal reflecting the obtained summarization data and provide the generated audio signal for presentation to the user that requested the audio-based summarization. In some embodiments, the platform can provide the obtained summarization data as an input to a text-to-audio generation engine that is configured to generate audio signals based on given text. In an illustrative example, the text-to-audio generation engine can generate audio signals having particular vocal features that are specific to the virtual assistant of the platform. Upon obtaining the generated audio signal, the platform can provide the audio signal for presentation to the user via one or more audio components (e.g., a speaker) of a client device of the user.

The client device of the user can initiate playback of the audio signals for the user via the one or more audio components. In some embodiments, the user can provide a notification to the client device that they would like to respond to the electronic messages (e.g., via a user interface (UI) of the client device, verbally, etc.). Upon detecting that the user has provided the notification, the platform can initiate recording of a verbal response provided by the user via one or more additional audio components (e.g., a microphone) of the client device. In some embodiments, the client device can generate an additional audio signal representing the recorded verbal response. The platform can generate an additional electronic message including a textual response to the one or more electronic messages based on the additional audio signal. In some embodiments, the platform generated the additional electronic message by providing the additional audio signal as an input to an AI model trained to generate electronic messages based on given audio signals. The AI model can be a general-purpose AI model, such as the AI model described above, or can be a specific-purpose AI model that is trained to generate electronic messages based on given audio signals only. In some embodiments, the AI model can generate additional electronic messages to match (or be similar to) a style or format preferred by the user.

In some embodiments, the platform can transmit the additional electronic message to a client device of a target recipient of the message. The target recipient can include a sender of the one or more electronic messages or another user of the platform. The electronic message can be presented to the target recipient as if the user had provided the response to the electronic message (e.g., via an application for the messaging channel of the electronic message). For example, the electronic message can have the preferred style or format of the user, as described above. In some embodiments, upon transmitting the additional electronic message to the client device of the target recipient, the platform can update metadata associated with the one or more electronic messages to indicate that the one or more electronic messages have been accessed (e.g., have been opened and/or read). In other or similar embodiments, the platform can update the metadata to indicate that the one or more electronic messages are to be erased from a memory of the platform.

Aspects of the present disclosure provide techniques for enabling a user to access audio-based summarization of electronic messages directed to the user and provide verbal responses to such electronic messages, which are provided to target recipients as an electronic message of the communication channel associated with the electronic messages directed to the user. By providing the user with audio-based summarizations of unread electronic messages in their inboxes or comment queues, the user is able to access such unread messages more quickly (e.g., compared to accessing each individual electronic message via one or more application(s) of the platform). Further, the verbal responses to such electronic messages can be provided more quickly and/or using more casual language than the user may use if they were drafting the responses via the one or more electronic messaging application(s) of the platform. This enables the user to spend less time and effort crafting responses to such electronic messages, enabling the user to respond to the messages more quickly. By enabling the user to access and/or respond to the electronic messages more quickly, the number of unread messages associated with the user decreases, which reduces the amount of memory space and/or processing resources consumed by the client device of the user and/or the overall computing system to maintain the user's message inboxes and/or comment queues. Such computing resources can be made available for other processes, which increases the overall efficiency and decreases the overall latency of the system.

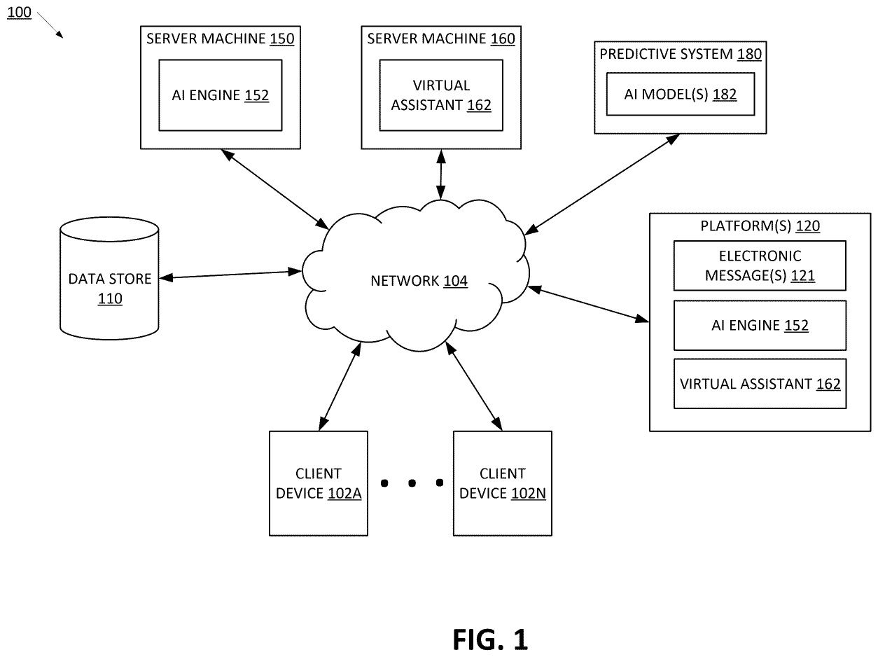

FIG. 1 illustrates an example system architecture 100, in accordance with implementations of the present disclosure. The system architecture 100 (also referred to as “system” herein) includes one or more client devices 102A-N, a data store 110, a platform 120 (e.g., a collaborative document platform, a productivity platform, etc.), one or more server machines (e.g., server machine 150, server machine 160, etc.), and/or a predictive system 180, each connected to a network 104. In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data can include data of and/or metadata associated with one or more electronic documents, in some embodiments. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines (e.g., server machines 130-140) coupled to the platform 120 via network 104.

Client devices 102A-N (collectively and individually referred to as client device(s) 102 herein) can include one or more computing devices such as personal computers (PCs), laptops, mobile phones, smart phones, tablet computers, netbook computers, network-connected televisions, etc. In some implementations, a client device 102 can also be referred to as a “user device.” Client devices 102 can include a content viewer. In some implementations, a content viewer can be an application that provides a user interface (UI) for users to view or upload content, such as images, media items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital media items, digital images, electronic books, etc.). In some implementations, the content viewer can be an electronic document platform application for users to generate, edit, and/or upload content for electronic documents on platform 120. In other or similar implementations, the content viewer can be an electronic messaging platform application (e.g., an electronic mail (e-mail) application) for users to generate and send messages via platform 120. As such, the content viewers can be provided to the client devices 102A-102N by platform 120.

In some implementations, platform 120 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to a file 121 (e.g., an electronic document, an e-mail message, etc.) and/or provide the file 121 to the user. For example, platform 120 can be an electronic document platform, such as a collaborative document platform or a productivity platform. The electronic document platform may allow a user to create, edit (e.g., collaboratively with other users), access or share with other users an electronic document stored at data store 110. In another example, platform 120 can allow a user to create, edit, or access electronic messages (e.g., e-mails) addressed to other users of the electronic messaging platform or users of client devices outside of the electronic messaging platform. Platform 120 can also include a website (e.g., a web page) or application back-end software that can be used to provide a user with access to files 121.

In some embodiments, functionalities of platform 120 can be supported by one or more AI models 182 (collectively and individually referred to as AI models 182 or AI model 182 herein) provided by predictive system 180. An AI model 182 can be trained to perform multiple types of tasks pertaining to the functionalities of platform 120 and/or files 121 of platform 120. Such tasks include, but are not limited to, content generation, content summarization, content expansion, data classification, knowledge retrieval, and so forth, as well as performing operations on behalf of a requesting user (e.g., creating a calendar invitation, generating and transmitting an electronic message, etc.). A user of platform 120 can access the AI model(s) 182 of predictive system 180 via one or more tools or resources of platform 120. For example, platform 120 can provide a client device 102 associated with a user with access to a user interface (UI) for an application that enables a user to create and/or edit a collaborative electronic document (e.g., a collaborative word document, a collaborative spreadsheet document, a collaborative slide presentation document, etc.). The UI can include one or more UI elements that enable the user to engage with the AI model(s) 182 of predictive system 180 in accordance with the functionality of the application. For instance, the UI can include a UI element that enables a user to request generated content from the AI model(s) 182. Upon detecting a user engagement with the UI element (e.g., via a UI of the client device 102), the platform can provide the request to predictive system 180. Predictive system 180 can provide a prompt associated with the request as an input to the AI model(s) 182 and can obtain an output of the model(s), which can include generated content, in accordance with the example. A prompt refers to a natural language text that requests the AI model(s) 182 to perform a specific task. In some embodiments, a prompt can include the request provided by the user and/or can include additional or alternative information associated with the request provided by the user. Platform 120 can update the UI provided to the client device 102 to include the generated content for presentation to the user. It should be noted that embodiments of the present disclosure are not limited to the tasks or functions explicitly described herein (e.g., content generation, content summarization, etc.) and embodiments can be applied to any type of task or function that could be performed by an AI model.

As described above, platform 120 can provide users with access to one or more electronic communication services that enable users to correspond with other users of platform 120 and/or non-users of platform 120. An electronic communication service includes any service that enables the transmission of electronic message(s) 121 between client devices 102 of system 100 or of other client devices of another system. In some embodiments, the electronic communication service can include an electronic mail (e-mail) communication service, a chat message communication service, and so forth. It should be noted that although some embodiments herein are described with respect to e-mail communication and chat messaging communication, such embodiments can be applied to any type of communication between users and/or between client devices 102 of users. For example, electronic message(s) 121 can include e-mail messages, chat messages (e.g., instant messages), comment messages associated with an electronic document associated with the platform 120 and/or users of the platform 120, messages transmitted during a virtual meeting hosted by the platform 120, messages and/or information associated with tasks or calendar events associated with users of the platform 120, and so forth.

As illustrated in FIG. 1, platform 120 can include an AI engine 152 and/or a virtual assistant 162. The AI engine 152 and/or virtual assistant 162 can provide users features and functionalities associated with audio-based electronic message management, as described herein. For example, AI engine 152 and/or virtual assistant 162 can identify one or more electronic messages 121 associated with a user platform 120 and, in some embodiments, AI engine 152 can generate a summary of the one or more electronic messages 121. The generated summary can be a textual representation of the content of the electronic message(s) 121 and, in some embodiments, AI engine 152 and/or virtual assistant 162 can generate or otherwise convert the textual representation of the electronic message(s) 121 to an audio signal. The virtual assistant 162 can provide the audio signal for presentation to the user via one or more audiovisual components of a client device 102 of the user (e.g., a speaker component). In some instances, the user can provide a verbal response to the summarization and, upon detection of the verbal response, virtual assistant 162 can initiate an operation to generate a recording of the verbal response (e.g., via a microphone component of client device 102). AI engine 152 and/or virtual assistant 162 can generate an additional electronic message 121 based on the recorded verbal response provided by the user. The generated electronic message 121 can have a style and/or a format that is preferred by the user, in some embodiments. AI engine 152 and/or virtual assistant 162 can provide the generated electronic message 121 to a client device 102 associated with another user of platform 120 and/or a client device 102 associated with a non-user of platform 120 (e.g., a user of another platform, etc.). Further details regarding providing the audio signal representing the summarization of the electronic messages 121 associated with a user and generating an additional electronic message based on a verbal response by the user are provided herein.

It should be noted that although FIG. 1 illustrates AI engine 152 and virtual assistant 162 as part of platform 120, in additional or alternative embodiments, one or more portions or components of AI engine 152 and/or virtual assistant 162 can reside and/or be executed at client device(s) 102. In other or similar embodiments, one or more components of AI engine 152 and/or virtual assistant 162 can reside on one or more server machines that are remote from platform 120. In an illustrative example, AI engine 152 can reside at server machine 150 and virtual assistant 162 can reside at server machine 160, in additional or alternative embodiments. It should be noted that in some other implementations, the functions of platform 120, server machine 150, server machine 160, and/or predictive system 180 can be provided by more or a fewer number of machines. For example, in some implementations, components and/or modules of platform 120, server machine 150, server machine 160, and/or predictive system 180 may be integrated into a single machine, while in other implementations components and/or modules of any of platform 120, server machine 150, server machine 160, and/or predictive system 180 may be integrated into multiple machines. In addition, in some implementations, components and/or modules of server machine 150, server machine 160, and/or predictive system 180 may be integrated into platform 120.

In general, functions described in implementations as being performed platform 120, server machine 150, server machine 160, and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

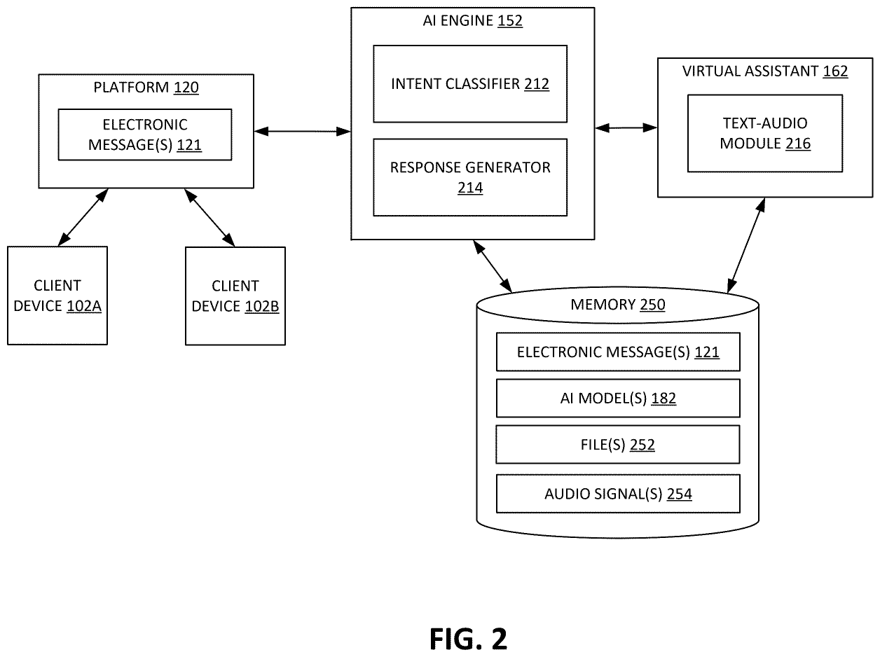

FIG. 2 is a block diagram of an example platform, an example artificial intelligence (AI) engine and an example virtual assistant, in accordance with implementations of the present disclosure. As described above, platform 129 can provide users with access to one or more electronic communication services, such as an e-mail service, a chat message service, etc., which involves the transmission of electronic message(s) 121 between two or more client devices 102 of system 100 (e.g., client device 102A and client device 102B). AI engine 152 and/or virtual assistant 162 can provide users with audio-based summarizations for electronic message(s) 121 associated with such users and/or generate electronic message(s) 121 based on verbal responses to the audio-based summarizations. Details regarding AI engine 152 and virtual assistant 162 are provided with respect to FIGS. 2-5. As illustrated by FIG. 2, platform 120, AI engine 152, and/or virtual assistant 162 can be connected to memory 250 (e.g., via network 104, via a bus, etc.). Memory 250 can include one or more portions of data store 110, in some embodiments. In other or similar embodiments, memory 250 can include or correspond to any memory of any component of system 100 and/or otherwise accessible to a component of system 100.

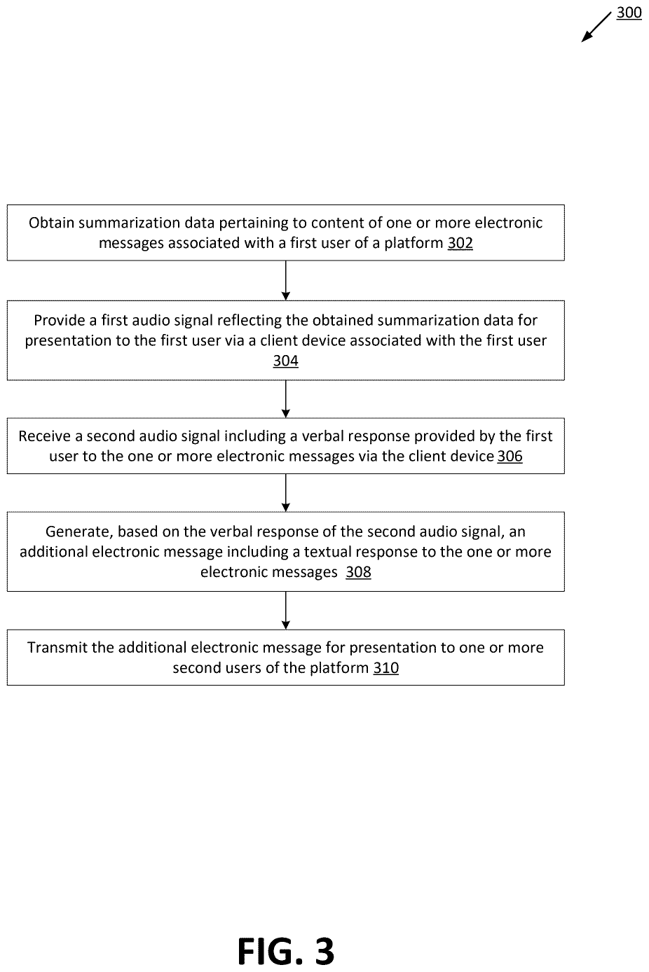

FIG. 3 depicts a flow diagram of an example method for audio-based electronic message management, in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by platform 120. For example, some or all of the operations of method 300 can be performed by AI engine 152 and/or virtual assistant 162.

At block 302, processing logic obtains summarization data pertaining to content of one or more electronic messages associated with a first user of a platform. In some embodiments, AI engine 152 and/or virtual assistant 162 can identify one or more electronic messages 121 associated with a first user. The electronic messages 121 can be included in or otherwise associated with a message inbox of an account associated with the first user, in some embodiments. For example, the electronic messages 121 can be included in an e-mail inbox and/or a chat message inbox of an account associated with the first user. In other or similar embodiments, the electronic messages 121 can be included in or otherwise associated with a message queue of an electronic document associated with the first user. For example, the electronic message(s) 121 can be included in or otherwise associated with a comment directed to the first user from a second user of platform 120. Upon detecting the comment provided by the second, platform 120 can include the message 121 in a message queue to be addressed by the first user. It should be noted that a “message inbox” and “message queue” are provided for the purpose of explanation and illustration only. Electronic message(s) 121 associated with a user can be identified in accordance with any technique associated with an electronic message communication medium of the present disclosure.

In some embodiments, processing logic can obtain the summarization data upon receiving a request from client device 102 for an audio-based summarization of one or more electronic messages 121 of a message inbox and/or a message queue for the first user. For example, as described herein, platform 120 can provide client devices 102 with one or more UIs that enable users to access and/or engage with features or functionalities of platform 120. In some embodiments, platform 120 can provide client device 102A (e.g., associated with the first user) with a UI that includes one or more UI elements that enable the user to request the audio-based summarization of the one or more electronic messages 121 of the message inbox of the first user. The UI element(s) can enable the user to provide a request to initiate an inbox summarization session with virtual assistant 162, in some embodiments. Upon detection of a user interaction with the one or more UI elements, processing logic can identify the one or more electronic messages 121 for which the summarization data is to be obtained. In some embodiments, the first user can provide an indication (e.g., via the UI of client device 102A) of the electronic messages 121 that are to be summarized. In other or similar embodiments, processing logic can identify one or more electronic messages 121 of the message inbox and/or message queue that satisfy one or more message criteria. In an illustrative example, an electronic message 121 can satisfy the one or more message criteria if such message 121 has not been accessed by the first user and/or a response to the message 121 has not been transmitted to a client device 102 of another user (or a non-user) of platform 120. In an additional or alternative example, an electronic message 121 can satisfy the one or more message criteria if such message 121 is associated with (e.g., contains content that is related to content of) an additional electronic message 121 that has not been accessed by the first user and/or a response to the additional message 121 has not been transmitted to a client device 102 of another user (or a non-user) of platform 120.

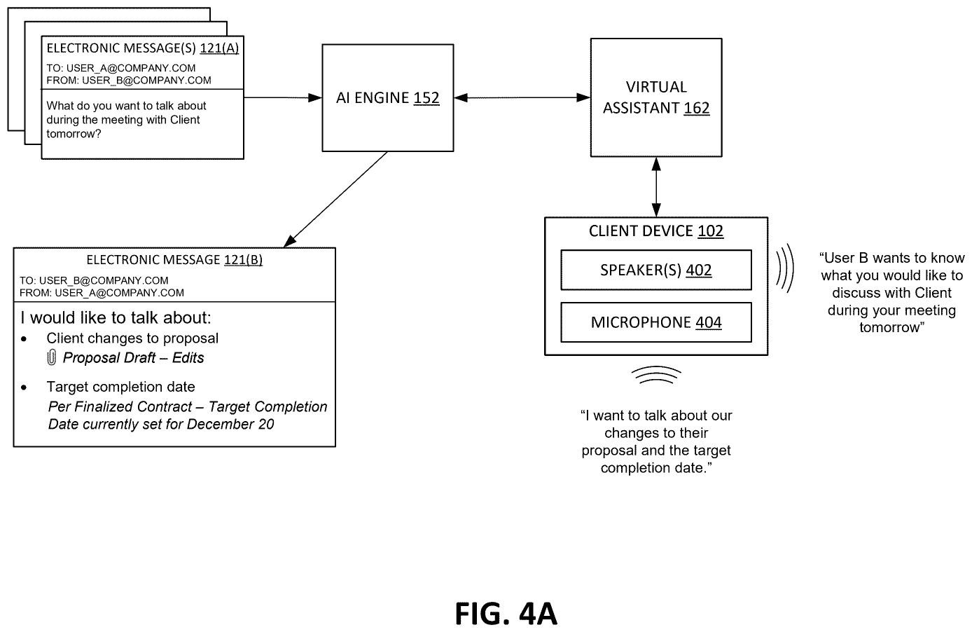

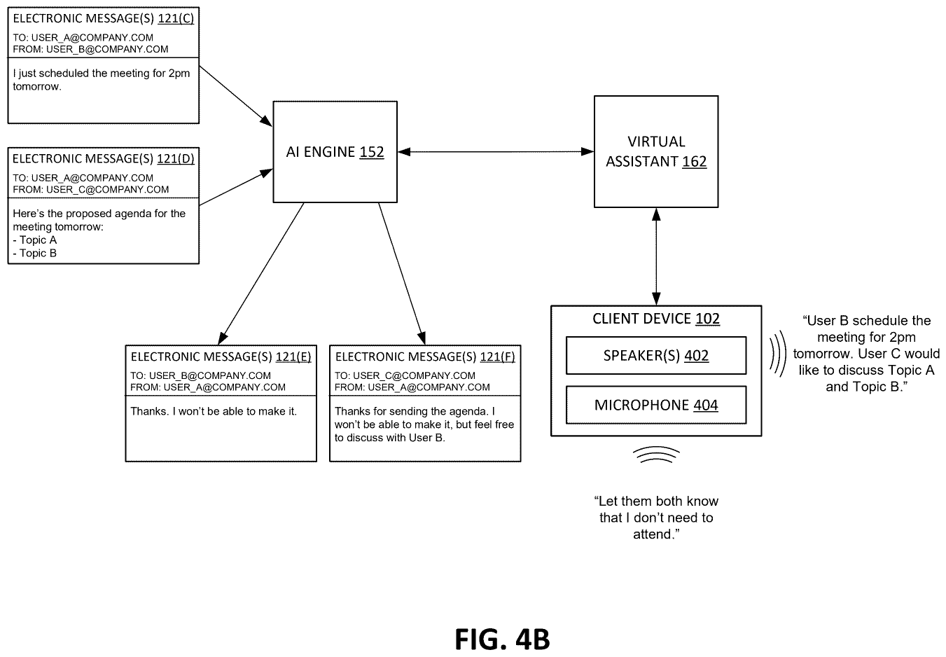

FIGS. 4A-4B illustrate examples of audio-based electronic message management using a virtual assistant, in accordance with implementations of the present disclosure. As illustrated by FIG. 4A, processing logic can identify one or more electronic messages 121 associated with the first user (e.g., User A). In an illustrative example, the identified one or more electronic messages 121 can include an electronic message 121A directed to the first user from a second user (e.g., User B). Content of the electronic message 121A can include “What do you want to talk about during the meeting with Client tomorrow?”

Referring back to FIG. 2, in some embodiments, AI engine 152 can have access to a message inbox and/or a message queue for the first user (e.g., in accordance with one or more functionalities or tasks of AI model(s) 182). For example, AI model(s) 182 can include one or more general-purpose models that are trained to handle a wide variety of tasks, including tasks relating to electronic messages 121 of platform 120. Generally, upon receiving a request to perform a task associated with AI model(s) 182 (e.g., based on a user interaction with a UI element of a UI), AI engine 152 can provide data corresponding to the request and/or the task as an input to the AI model(s) 182 and obtain a response based on one or more outputs of the AI model(s) 182. AI engine 152 can provide the obtained response for presentation to the user via a client device 102 in accordance with the requested task.

As illustrated by FIG. 2, AI engine 152 can include an intent classifier 210 and/or a response generator 214. As a general purpose AI model is trained to handle a wide variety of tasks, intent classifier 212 can determine an intent associated with a request to perform a task of the one or more AI model(s) 182. In some embodiments, intent classifier 212 can determine the intent of the request based on the UI element (or other such mechanism) that initiated transmission of the request. For example, the user can initiate the request to perform a particular task by engaging with a UI element corresponding to the particular task. Accordingly, intent classifier 212 can determine the intent of the request by determining that the request was received based on a user engagement with the corresponding UI element. In other or similar embodiments, intent classifier 212 can determine the intent of the request based on content of the request and/or information provided with the request. For example, using one or more UI elements of a UI provided by platform 120, a user may provide a request to “generate an e-mail message responding to an email from user B.” Intent classifier 212 can determine, based on the content of the request, that the intent of the request is generation of an e-mail message, in such example. In some embodiments, intent classifier 212 can determine the intent of a request based on one or more pre-defined intent rules for the AI model(s) (e.g., as provided by a developer or operator of platform 120, as determined based on historical or test data associated with platform 120). In other or similar embodiments, one or more of AI model(s) 182 can be trained to predict an intent of a request. Intent classifier 212 can determine the intent of a request by providing the request as an input to the one or more AI model(s) 182 and obtaining one or more outputs of such AI model(s) 182.

In accordance with embodiments described herein, upon receiving a request of the first user to obtain summarization data associated with one or more electronic messages 121 (e.g., electronic message 121a) associated with the first user, intent classifier 212 can determine an intent of the request, as described above. In an illustrative example, intent classifier 212 can determine (e.g., based on the UI element(s) that initiated the request, based on the content and/or information associated with the request, etc.) that the intent of the request is to generate a summary of the one or more electronic messages 121.

Response generator 214 of AI engine 152 can generate one or more responses to a request directed to a general purpose AI model 182. A generated response can be specific to the determined intent of the request. For example, a generated response for a request to generate an e-mail message can include content of the e-mail message and/or an electronic file 252 that can be transmitted to a client device 102 as an e-mail message. In another example, a generated response for a request to summarize content of an electronic message 121 and/or a file 252 can include a summarization of the content. In some embodiments, response generator 214 can identify information or data associated with the request and can provide the identified information or data as an input to an AI model 182. In some embodiments, the information or data can be included in the content of the request (e.g., as provided by the user). In other or similar embodiments, response generator 214 can retrieve the information and/or data (e.g., from memory 250, from data store 110, from another memory of or accessible to components of system 100, etc.). Response generator 214 can obtain one or more outputs of the AI model 182 and can extract the generated response to the request from the obtained one or more outputs.

In accordance with embodiments herein, response generator 214 can generate a response to the request to summarize the one or more electronic messages 121 associated with the first user. In some embodiments, response generator 214 can retrieve the one or more electronic messages 121 from the message inbox and/or message queue associated with the first user and can provide the retrieved message(s) 121 as an input to the AI model(s) 182 with a prompt instructing the AI model(s) 182 to generate a summary of the message(s) 121. In additional or alternative embodiments, response generator 214 can retrieve additional data or information pertaining to the electronic message(s) 121 and provide such retrieved data or information as an input to the AI model(s) 182. For example, response generator 214 (or another component of AI engine 152 or platform 120) can determine that an electronic message 121 references an electronic document associated with one or more users of platform 120. Response generator 214 can retrieve a file 252 associated with such electronic documents and can provide the file 252 and/or content extracted from the file 252 as an input to the AI model(s) 182 (e.g., with the electronic messages 121 and/or the prompt). Response generator 214 can obtain one or more outputs of the AI model(s) 182, which can include summarization data including the summary of the electronic message(s) 121. The additional data can include, in some embodiments, one or more calendar entries of a calendar associated with the first user and/or one or more second users (e.g., senders of the electronic message 121, etc.) of platform 120, an indication of one or more electronic documents associated with the at least one of the first user or the one or more second users, an indication of one or more prior electronic messages 121 between the first user and the one or more second user, an indication of one or more prior electronic messages 121 between the first user and one or more third users of platform 120, and/or an indication of one or more user preferences associated with the first user.

It should be noted that although some embodiments describe AI model(s) 182 as general purpose AI models, AI model(s) 182 can include one or more specific purpose AI models that are each trained to perform a specific task (e.g., generating a summary of content of one or more electronic message(s) 121, generating an electronic message 121 based on an audio signal including a verbal response provided by a user, etc.). In such embodiments, upon receiving a request to generate the summary of the electronic message(s) 121 and/or determining the intent of such request, response generator 214 can identify a particular AI model 182 that is trained to perform the task of the request and can provide the electronic message(s) 121 and/or the additional information or data as an input to such AI model 182. In some embodiments, response generator 214 may not provide a prompt instructing the AI model 182 to generate the summary as an input to the AI model 182 (e.g., as the AI model is trained specifically to perform the task of generating a summary). Response generator 214 can obtain the summarization data based on one or more outputs of such AI model 182, as described above.

Referring back to FIG. 3, at block 304, processing logic provides a first audio signal reflecting the obtained summarization data for presentation to the first user via a client device associated with the first user. In some embodiments, virtual assistant 162 can include a text-audio module 216 that can convert textual data to an audio signal and/or an audio signal to textual data. In some embodiments, text-audio module 216 can include or otherwise correspond to a text-to-speech (TTS) engine that converts written text into spoken audio by synthesizing speech. The spoken audio can have characteristics (e.g., vocal characteristics) that are specific to the virtual assistant 162 (e.g., as provided by a developer or operator of platform 120).

In some embodiments, text-audio module 216 can obtain textual data (e.g., a generated summary of one or more electronic messages 121) and can modify the textual data to have a more speech-friendly format. In an illustrative example, text-audio module 216 can expand abbreviations or numbers (e.g., expand “Dr.” to “Doctor” or “25” to “twenty-five,” insert or otherwise modify punctuation of the textual data to better match a speech-friendly format, and so forth. In some embodiments, text-audio module 216 can modify the textual data based on one or more speech-friendly formatting rules (e.g., as provided by a developer or operator of platform 120, determined based on historical or test data associated with platform 120, etc.). In other or similar embodiments, text-audio module 216 can provide the textual data as input to an AI model that is trained to modify given textual data to have the speech-friendly format and can obtain the modified data based on one or more outputs of such AI model 182.

In some embodiments, text-audio module 216 can perform one or more TTS analysis operations to determine one or more audio characteristics of the modified textual data. The TTS analysis operations can include, but are not limited to, converting the modified textual data into phonemes (e.g., the smallest units of sound in a language), generating one or more mapping words of phrases of the modified textual data to phonetic equivalents based on language-specific pronunciation rules or dictionaries, determining prosody data (e.g., a pitch, duration, rhythm, etc.) for first audio signal based on the voice characteristics of the virtual assistant and the content of the modified textual data, and so forth. One or more outputs of the TTS analysis operations can include phonetic data and/or prosody data, which indicates the phonemes, the generated one or more mappings, and/or the prosody data. In some embodiments, text-audio module 216 can provide the modified textual data and/or the one or more outputs of the TTS analysis operations as an input to a speech synthesis engine that converts the modified textual data to an audio waveform. The speech synthesis engine can include a concatenative synthesis engine (e.g., that concatenates pre-recorded segments of speech, such as phonemes or words, to form complete speech), a parametric synthesis engine (e.g., that applies one or more mathematical models to generate speech based on phonetic and/or prosodic inputs), a neural speech synthesis engine (e.g., that applies one or more deep learning models to generate realistic and fluid speech by predicting the waveform from the phonetic and prosody information), or another type of synthesis engine, in accordance with embodiments of the present disclosure. Text-audio module 216 can obtain one or more outputs of the speech synthesis engine, which can include an audio signal reflecting the obtained summarization data associated with the one or more electronic messages 121 of the first user. As illustrated by FIG. 2, memory 250 can store one or more audio signals 254. In some embodiments, virtual assistant 162 can store the audio signal at memory 250 as first audio signal 254A.

It should be noted that although embodiments described above provide that text-audio module 216 performs one or more operations associated with converting the textual data to the first audio signal 254A, in other or similar embodiments, text-audio module 216 may provide the obtained summarization data as input to a TTS model that is trained to generate audio signals based on given text data. Such TTS model can perform one or more of the above described operations. In such embodiments, text-audio module 216 can obtain one or more outputs of the TTS model and extract the first audio signal 254A from the obtained one or more outputs.

Upon obtaining the audio signal reflecting the obtained summarization data, virtual assistant 162 can provide the audio signal for presentation to the first user. As illustrated by FIG. 4A, the virtual assistant 162 can initiate playback of the first audio signal 254A via a one or more speakers 402 of a client device 102 (e.g., client device 102A). In accordance with the previously illustrative example, the audio signal can include a voice of the virtual assistant saying, “User B wants to know what you would like to discuss with Client during your meeting tomorrow” (e.g., in accordance with the content of electronic message 121(a)).

Referring back to FIG. 3, at block 306, processing logic receives a second audio signal including a verbal response provided by the first user to the one or more electronic messages via the client device. In some embodiments, the first user of client device 102A can provide a verbal response to the summary of the electronic message(s) 121 (e.g., upon hearing the audio signal 254A provided by virtual assistant 162 via speaker(s) 402). In some embodiments, the first user can engage with one or more UI elements of a UI of client device 102 to indicate that they wish to provide the verbal response. Upon detecting the user engagement, virtual assistant 162 can initiate recording of the virtual response by a microphone 404 of client device 102. In other or similar embodiments, upon completion of playback of the first audio signal 254A, virtual assistant 162 can initiate recording by microphone 404 for a particular time period. Microphone 404 can capture any audio signal provided by the first user during the time period. Accordingly, the first user can provide the verbal response during such time period. Microphone 404 can generate a second audio signal based on the recording of the audio provided by the first user, which can include the verbal response to the summary. As illustrated by FIG. 4A, the first user can provide the verbal response of “I want to talk about our changes to their proposal and the target completion date.” Microphone 404 can generate the audio signal based on the recording of the provided verbal response, as described above. In some embodiments, virtual assistant 162 can store the generated audio signal based on the first user's verbal response at memory 250 as audio signal 254B.

At block 308, processing logic generates, based on the verbal response of the second audio signal, an additional electronic message including a textual response to the one or more electronic messages. In some embodiments, text-audio module 216 can convert the second audio signal 256B to textual data and provide the textual data as an input to AI model(s) 182. For example, in some embodiments text-audio module 216 can include or otherwise correspond to an automatic speech recognition (ASR) engine that converts spoken language or audio into written text. In some embodiments, text-audio module 216 can perform one or more feature extraction operations to extract one or more features of the second audio signal 254B. The one or more features can include breaking down the audio signal into key characteristics of speech sound, such as Mel-Frequency Cepstral Coefficients (MFCCs). In some embodiments, text-audio module 216 can additionally or alternatively perform one or more modeling operations, which include mapping the one or more extracted audio features to corresponding phonemes and/or language features (e.g., based on the language of the speech of the second audio signal 256B). Mapping the audio features to the corresponding phonemes can be performed using one or more deep learning models or Hidden Markov Models (HMMs), which are trained to detect variability in speech, in some embodiments. In other or similar embodiments, mapping the audio features to the corresponding phonemes can be performed using a context-dependent phoneme model. In some embodiments, text-audio module 216 can generate the mapping between the extracted audio features and the language features using a N-gram model, a recurrent neural network (RNN), a transformer-based model, etc. that is trained to recognize words of audio signals and predict word sequences of the audio signals based on linguistic rules and patterns.

Text-audio module 216 can provide the second audio signal 256B, the extracted audio features, and/or the generated mappings as an input to a speech decoder engine, which generates written text based on given audio data. The speech decoder engine can align the audio signal 256B and/or extracted textual features with the generated mappings to determine a sequence of words of the audio signal. In some embodiments, the speech decoder engine can implement or otherwise use a beam search model, which predicts the most probable word sequence based on given input sounds. Text-audio module 216 can extract the textual data representing the verbal response provided by the first user from one or more outputs of the speech decoder engine.

It should be noted that although embodiments described above provide that text-audio module 216 performs one or more operations associated with converting the second audio signal 254B to textual data representing the verbal response provided by the first user, in other or similar embodiments, text-audio module 216 may provide the second audio signal 254B as input to an ASR model that is trained to generate textual data based on given audio data. Such ASR model can perform one or more of the above described operations. In such embodiments, text-audio module 216 can obtain one or more outputs of the ASR model and extract the textual data representing the verbal response provided by the first user from the obtained one or more outputs.

In some embodiments, virtual assistant 162 can provide the textual data representing the verbal response to AI engine 152. Virtual assistant 162 can also provide a request to generate content of an electronic message 121 based on the verbal response indicated by the textual data. In some embodiments, intent classifier 212 can determine an intent of the request provided by virtual assistant 162, as described above. Response generator 214 can generate a response to the provided request based on one or more outputs of AI model(s) 182, as described herein. For example, the AI model(s) 182 can be trained to perform a wide variety of tasks, including generating content of an electronic message 121 based on given textual data and/or audio data, in some embodiments. Response generator 214 can provide the textual data and/or a prompt instructing the AI model(s) 182 to generate the content of the electronic message 121 as an input to the AI model(s). Response generator 214 can obtain one or more outputs of the AI model(s) 182, which can include the content of the electronic message (e.g., in accordance with the intent determined by intent classifier 212). In other or similar embodiments, the AI model(s) 182 can be specifically trained to generate content of an electronic message 121 based on given textual data and/or audio data (e.g., without being trained to perform other tasks). In some embodiments, response generator 214 can provide the textual data as an input to the AI model(s) 182 (e.g., without providing the prompt) and obtain one or more outputs of the AI model(s) 182. The one or more outputs can include content of an electronic message 121 based on the verbal response provided by the first user, as described above.

In additional or alternative embodiments, virtual assistant 162 may not convert the second audio signal 254A to the textual data and instead may provide the second audio signal 254B to AI engine 152 (e.g., to be provided directly as an input to AI model(s) 182). In such embodiments, AI model(s) 182 may be trained to generate content of an electronic message 121 based on a given audio signal. Response generator 214 can provide the second audio signal 254B as an input to the AI model(s) 182 (e.g., with or without a prompt) and can obtain one or more outputs of the AI model(s) 182. In some embodiments, the one or more outputs of the AI model(s) 182 can include content of the electronic message based on the verbal response of the first user, as described above.

In some embodiments, response generator 214 may provide additional data as an input to the AI model(s). The additional data can include, in some embodiments, one or more calendar entries of a calendar associated with the first user and/or one or more second users (e.g., senders of the electronic message 121, etc.) of platform 120, an indication of one or more electronic documents associated with the at least one of the first user or the one or more second users, an indication of one or more prior electronic messages 121 between the first user and the one or more second user, an indication of one or more prior electronic messages 121 between the first user and one or more third users of platform 120, and/or an indication of one or more user preferences associated with the first user. AI engine 152 and/or virtual assistant 162 can retrieve the additional data in accordance with previously described embodiments.

In some embodiments, AI model(s) 182 can generate content of an electronic message (e.g., based on given textual data and/or a given audio signal) that has a format or style preferred by the first user. For example, such AI model(s) 182 can be trained using a training data set including content having a preferred style or format of the first user. In other or similar embodiments, AI engine 182 can identify content having the preferred style or format of the first user and can provide the identified content with the textual data and/or the second audio signal 254B as an input to the AI model(s) 182. The content having the preferred style or format of the first user can include prior electronic messages 121 transmitted from the client device 102A of the first user, content of one or more electronic documents associated with the first user, and/or content indicating by the first user (e.g., via a UI of the first client device 102A) as having the preferred style or format of the first user. In such embodiments, the content of the electronic message generated by AI model(s) 182 based on the verbal response of the first user can have a format or style matching, or approximately matching, the preferred style or format of the first user.

In other or similar embodiments, AI model(s) 182 can generate content that has a format or style corresponding to a type of the content (e.g., in view of content formatting or style rules associated with the platform 120). For example, AI model(s) 182 and/or AI engine 152 can determine that content of the verbal response provided by the first user can have a list-type format and accordingly generate content of the electronic message 121 to have the list-type format.

In some embodiments, the content generated by AI model(s) 182 can include an indication or reference to additional data corresponding to the content of the verbal response provided by the first user. AI engine 152 may identify, based on the given textual data and the second audio signal 254A, one or more electronic documents that are associated with the content of the verbal response and, in some embodiments, may provide the electronic documents as an input to the AI model(s) 182, in some embodiments. In such embodiments, AI model(s) 182 can generate the content based on information of the electronic documents. In accordance with the previously illustrative example, the verbal response of the first user can be “I want to talk about our changes to their proposal and the target completion date.” AI engine 152 may identify (e.g., of a set of electronic documents associated with the first user) an electronic document associated with the client proposal (e.g., based on a title or content of the electronic document) and an additional electronic document that indicates the target completion date of the project (e.g., based on the title or content of the additional electronic document). AI engine 152 can provide such electronic documents as an input to the AI model(s) 182 and the AI model(s) 182 can generate the content of the electronic message based on content of the electronic document.

As illustrated in FIG. 4A, electronic message 121B can include content generated by AI model(s) 182 based on the verbal response of the first user. The generated content can have a style or format that is preferred by the first user and/or that corresponds to a type of the content. The generated content can also include a reference to the electronic document associated with the client proposal and/or an indication of the target completion date for the project (e.g., as provided by the additional electronic document).

Referring back to FIG. 3, at block 310, processing logic transmits the additional electronic message for presentation to one or more second users of the platform. In some embodiments, AI engine 152 and/or virtual assistant 162 (or another component of platform 120) can identify a recipient of the additional electronic message (e.g., electronic message 121B of FIG. 4A). AI engine 152 and/or virtual assistant 162 can identify the recipient as the sender of the message transmitted to the first user (e.g., User B), in some embodiments. In other or similar embodiments, AI engine and/or virtual assistant 162 can identify the recipient based on one or more additional electronic messages 121 included in a message inbox and/or a message queue of the first user and the content of the electronic message 121B. For example, the content of electronic message 121B can include a question posed to an additional user of platform 120 (e.g., who may be different from the sender of electronic message 121A). AI engine 152 and/or virtual assistant 162 can identify one or more electronic messages 121 included in the message inbox and/or the message queue of the first user that relate to the question and identify the sender of such messages 121. AI engine and/or virtual assistant 162 can identify such sender as the intended recipient of the electronic message 121B in some embodiments.

Upon identifying the recipient of electronic message 121B, platform 120 can transmit the electronic message to a client device 102 associated with the recipient (e.g., client device 102B). In some embodiments, the recipient can be another user (e.g., a second user) of platform 120. In other or similar embodiments, the recipient can be a non-user of platform 120. Such non-user may use a different electronic communication service offered by another platform, in some embodiments.

FIG. 4B illustrates an additional example of audio-based electronic message management using a virtual assistant, in accordance with implementations of the present disclosure. As illustrated by FIG. 4B, AI engine 152 and/or virtual assistant 162 can identify an electronic message 121C directed to the first user from the second user and an electronic message 121D directed to the first user from a third user (e.g., user C). Virtual assistant 162 can provide an audio signal for presentation to the first user, which includes a summarization of electronic messages 121C and 121D, in accordance with embodiments described above. The first user can provide a verbal response to the summarization (e.g., “Let them both know that I don't need to attend,” in accordance with previously described embodiments. AI engine 152 can generate content of electronic message 121E directed to the second user and content of electronic message 121F directed to the third user based on the verbal response provided by the first user. As illustrated by FIG. 4B, content of the electronic message 121E to the second user is different from content of the electronic message 121F directed to the third user. Accordingly, embodiments of the present disclosure enable the first user to provide a single verbal response, which is used to generate multiple electronic messages 121 (e.g., electronic message 121E and electronic message 121F) that include content that is specific to the recipient of such electronic messages.

In additional or alternative embodiments, AI engine 152 may generate a message template based on the verbal response provided by the first user (e.g., instead of generating and transmitting the message 121, as described above). For example, the first user can provide their verbal response to the summarization and/or explanation of the message 121, as described above. AI engine 152 and/or virtual assistant 162 can provide the verbal response and/or a textual version of the verbal response as an input to AI model(s) 182, as described above, and can obtain one or more outputs of AI model(s) 182. The one or more outputs can include a template of a message 121 that is generated based on the verbal response provided by the first user. In some embodiments, AI engine 152 and/or virtual assistant 162 can provide the template for presentation to the first user via a UI of client device 102A. The first user can review the template via a UI of client device 102A. In some embodiments, the UI can include one or more UI elements that enable the first user to initiate transmission of the message 121 indicated by the template (e.g., a “send” button) to a client device 102 of the second user and/or edit content of the message 121 indicated by the template. Upon detecting that the first user has interacted with a UI element to initiate transmission of the message, platform 120 can transmit the message 121 of the template to client device 102B, as described above. Upon detecting that the user has interacted with a UI element to edit content of the message 121, client device 102A can update the UI to enable the first user to edit the content of the message 121. In some embodiments, AI engine 152 and/or virtual assistant 162 can provide a notification of the edits provided by the first user to predictive system 180 (e.g., for retraining AI model(s) 180).

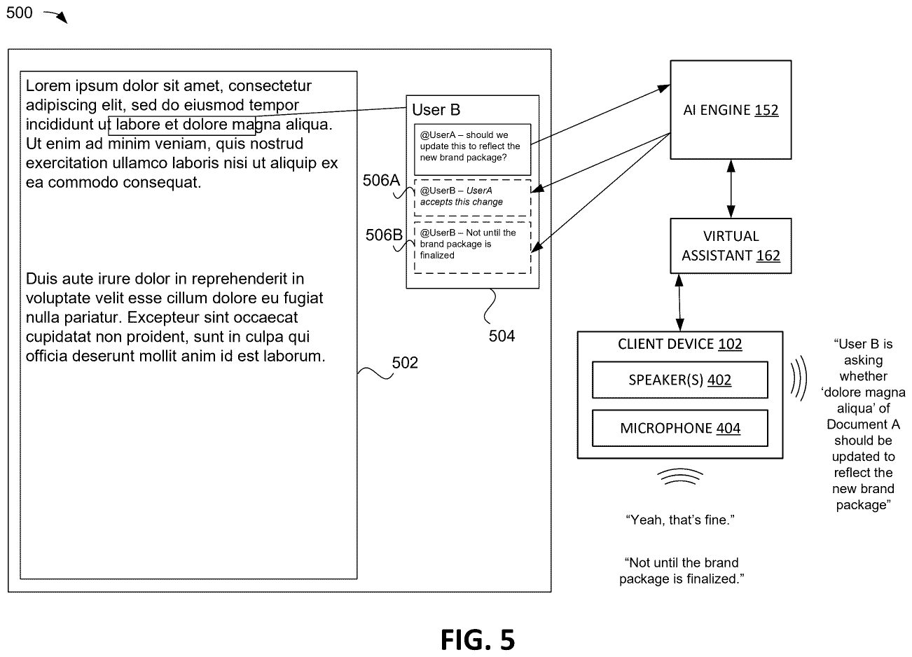

FIG. 5 illustrates another example of audio-based electronic message management using a virtual assistant, in accordance with implementations of the present disclosure. As noted above, although some embodiments of the present disclosure are directed to e-mail communication or chat message communication between users (or non-users) of platform 120, such embodiments can be applied to other types of messages directed to a user of platform 120. For example, FIG. 5 illustrates a UI 500 of platform 120 that provides a user with access to an electronic document 502. In an illustrative example, the second user of platform 120 (e.g., User B) provided a comment 504 with respect to content of electronic document 502 that is directed to the first user (e.g., “@UserA - should we update this to reflect the new brand package?”). Upon detecting that the second user has provided the comment 504 directed to the first user, platform 120 can update a message queue associated with the first user (or client device 102A of the first user) to include the message of the comment. As described above, AI engine 152 and/or virtual assistant 162 can identify the message of the message queue and can generate and provide the audio signal including a summary of the comment for presentation to the first user, in accordance with previously described embodiments. As illustrated by FIG. 5, the audio signal provided for presentation to the first user can include the statement “User B is asking whether ‘dolore magna aliqua’ of Document A should be updated to reflect the new brand package.” In one example, the first user can provide a first verbal response of “Yeah, that's fine.” AI engine 152 and/or virtual assistant 162 can generate content of a first response 506A to the comment 504 based on the first verbal response, which can indicate that the first user has accepted the change proposed by the second user. As illustrated by FIG. 5, platform 120 can update the UI 500 to include the first response 506A to the comment 504, which indicates that the first user has accepted the change. In another example, the first user can provide a second verbal response of “Not until the brand package is finalized.” AI engine 152 and/or virtual assistant 162 can generate content of a second response 506B based on the second verbal response and can update UI 500 to include a second response 506B to the comment 504.

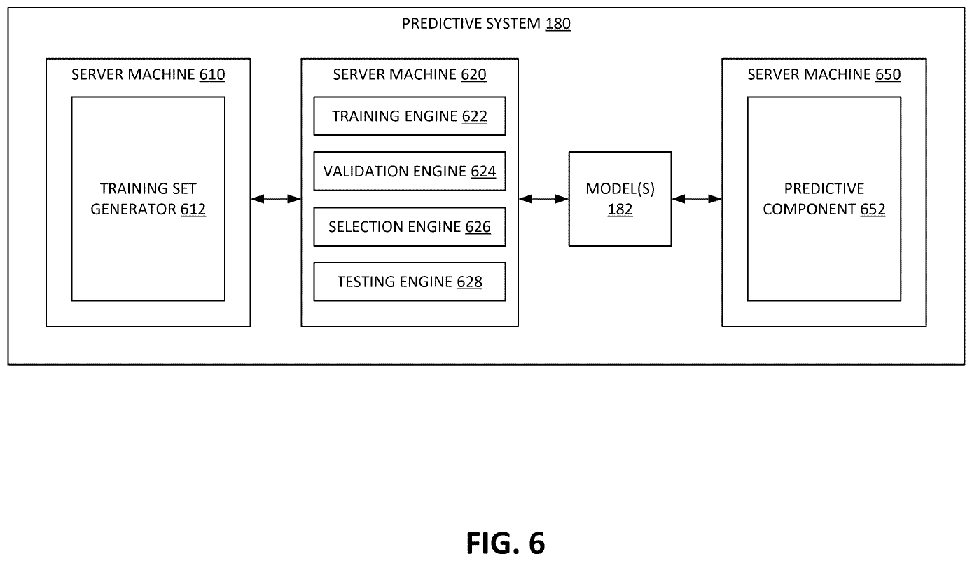

FIG. 6 depicts a block diagram of an example predictive system, in accordance with implementations of the present disclosure. As illustrated in FIG. 6, predictive system 180 can include a training set generator 612 (e.g., residing at server machine 610), a training engine 612, a validation engine 624, a selection 626, and/or a testing engine 628 (e.g., each residing at server machine 620), and/or a predictive component 652 (e.g., residing at server machine 650). Training set generator 612 may be capable of generating training data (e.g., a set of training inputs and a set of target outputs) to train AI model(s) 182.

In some embodiments, AI model(s) 182 can include a general purpose model that is trained to perform a wide variety of tasks. In such embodiments, training set generator 612 can generate a training data set for training AI model(s) 182 based on a corpus of textual data, audio data, video data, and so forth. The corpus can include a wide array of information gathered from numerous sources, including publicly available web pages (e.g., blogs, forums, news sites, academic papers, online encyclopedias, etc.), books and literature, social media, research papers, public datasets, and so forth. Training set generator 612 can extract features from data of the corpus and can transform the extracted features into a format that the AI model(s) 182 can interpret. In some embodiments, training set generator 612 can perform one or more tokenization operations (e.g., to break down the textual data, audio data, video data, etc. into smaller units called tokens), one or more normalization operations (e.g., to convert the tokens into a common format and/or a format that can be handled by the AI model(s) 182), one or more noise removal operations (e.g., to remove or filter out unwanted data or metadata), and/or one or more data formatting operations (e.g., to structure the tokens uniformly and indicate contextual windows between tokens indicating dependencies between tokens). In some embodiments, training set generator 612 can obtain annotation data for the tokens obtained based on the data of the corpus. Annotation data can include an indication of a classification associated with the token. In some embodiments, the annotation data can be provided by human annotators or according to other annotation techniques. Training set generator 612 can update the training data set to include the extracted features, the generated tokens, and/or the annotation data. As described below, training engine 622 can use the training data to perform the wide range of tasks.

Training engine 622 can train an AI model 182 using the training data from training set generator 612, as described above. The machine learning model 182 can refer to the model artifact that is created by the training engine 622 using the training data that includes training inputs and/or corresponding target outputs (correct answers for respective training inputs). The training engine 622 can find patterns in the training data that map the training input to the target output (the answer to be predicted), and provide the machine learning model 182 that captures these patterns. The machine learning model 182 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like.

In some embodiments, training engine 622 can first pre-train the AI model 182 on a corpus of text (e.g., generated by or accessible to training set generator 612 and/or training engine 622) to create a foundational model, and afterwards fine-tuned on more data pertaining to a particular set of tasks to create a more task-specific, or targeted, model. The foundational model can first be pre-trained using a corpus of text that can include text context in the public domain, licensed content, and/or proprietary content. Such a pre-training can be used by the model to learn broad language elements including general sentence structure, common phrases, vocabulary, natural language structure, and any other elements commonly associated with natural language in a large corpus of text. In some embodiments, this first, foundational model can be trained using self-supervision, or unsupervised training on such datasets.

In some embodiments, the AI model 182 can then be further trained and/or fine-tuned on organizational data, including proprietary organizational data. The AI model 182 can also be further trained and/or fine-tuned on organizational data associated with an electronic message 121 and/or other documents, including proprietary organizational data associated with an electronic message 121 and/or other documents.

In some embodiments, the second portion of training, including fine-tuning, may be unsupervised, supervised, reinforced, or any other type of training. In some embodiments, this second portion of training may include some elements of supervision, including learning techniques incorporating human or machine-generated feedback, undergoing training according to a set of guidelines, or training on a previously labeled set of data, etc. In a non-limiting example associated with reinforcement learning, the outputs of the AI model 182 while training may be ranked by a user, according to a variety of factors, including accuracy, helpfulness, veracity, acceptability, or any other metric useful in the fine-tuning portion of training. In this manner, the AI model 182 can learn to favor these and any other factors relevant to users within an organization, or associated with a virtual meeting, when generating a response. In such a way, a foundational model can be further trained to perform within a virtual meeting, and provide useful information, as well as help to accomplish useful tasks associated with the virtual meeting.

In some embodiments, the AI model 182 may include one or more pre-trained models, or fine-tuned models. In a non-limiting example, in some embodiments, the goal of the “fine-tuning” may be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

In one embodiment, the AI model 182 may be one or more of decision trees, random forests, support vector machines, or other types of machine learning models. In one embodiment, the AI model 145 may be one or more artificial neural networks (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

In some embodiments, the AI model 182 may be one or more recurrent neural networks (RNNs). An RNN is a type of neural network that includes a memory to enable the neural network to capture temporal dependencies. An RNN is able to learn input-output mappings that depend on both a current input and past inputs. The RNN will address past and future measurements and make predictions based on this continuous measurement information. One type of RNN that may be used is a long short term memory (LSTM) neural network.

As indicated above, the AI model 182 may be one or more generative AI models, allowing for the generation of new and original content. The generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks.

In additional or alternative embodiments, an AI model 182 may be a specific purpose AI model that is trained to perform a specific task. For example, AI model 182 may be trained to generate a summary of content based on given text data including the content. In such example, training set generator 612 can generate the training data by identifying one or more segments of content (e.g., of electronic documents of platform 120, of electronic messages 121 of platform 120, etc.) and a summary associated with the segments of content. The summary may be provided by a user of platform 120 and/or a human annotator of platform 120 (or another platform or system). Training set generator 612 can generate an input/output mapping, where the input includes the content segments and the output includes the summary associated with the content segments, and can update the training data set to include the generated input/output mapping.

In another example, AI model 182 may be trained to generate content of an electronic message based on given textual data and/or a given audio signal. In such example, training set generator 612 can generate the training data by identifying textual data and/or audio data (e.g., included in electronic documents of platform 120, of electronic messages 121 of platform 120, provided by users of platform 120, etc.) and content of an electronic message associated with the textual data and/or audio data. The content of the electronic message may be provided by a user of platform 120 and/or a human annotator of platform 120 (or another platform or system). Training set generator 612 can generate an input/output mapping, where the input includes the textual data and/or the audio data and the output includes the content of the electronic message associated with the textual data and/or audio data, and can update the training data set to include the generated input/output mapping. Training engine 622 may train the AI model 182 using such training data sets, in accordance with previously described embodiments.

Validation engine 624 may be capable of validating a trained machine learning model 182 using a corresponding set of features of a validation set from training set generator 612. The validation engine 624 may determine an accuracy of each of the trained machine learning models 182 based on the corresponding sets of features of the validation set. The validation engine 624 may discard a trained machine learning model 182 that has an accuracy that does not meet a threshold accuracy. In some embodiments, the selection engine 626 may be capable of selecting a trained machine learning model 182 that has an accuracy that meets a threshold accuracy. In some embodiments, the selection engine 626 may be capable of selecting the trained machine learning model 182 that has the highest accuracy of the trained machine learning models 182.

The testing engine 686 may be capable of testing a trained machine learning model 182 using a corresponding set of features of a testing set from training set generator 612. For example, a first trained machine learning model 182 that was trained using a first set of features of the training set may be tested using the first set of features of the testing set. The testing engine 628 may determine a trained machine learning model 182 that has the highest accuracy of all of the trained machine learning models based on the testing sets.

Predictive component 652 of server 650 may be configured to feed data as input to model 182 and obtain one or more outputs. In some embodiments, predictive component 652 can include or be associated with AI engine 152 and/or virtual assistant 162. For example, predictive component 652 can include or be associated with intent classifier 210 and/or response generator 214. In such embodiments, predictive component 652 can feed textual data and/or audio signals as an input to model(s) 182, in accordance with previously described embodiments.

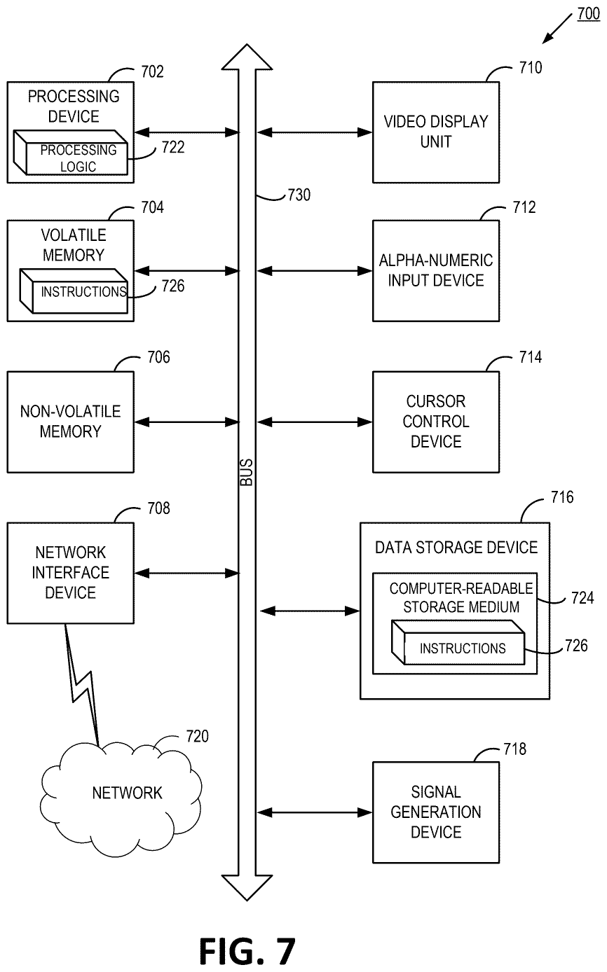

FIG. 7 is a block diagram illustrating an exemplary computer system 1000, in accordance with implementations of the present disclosure. The computer system 1000 can correspond to platform 120, client devices 102A-N, server machine 150, server machine 160, and/or predictive system 180 described herein and with respect to FIGS. 1-6. Computer system 1000 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processing device (processor) 1002, a main memory 1004 (e.g., read-only memory (ROM), flash memory, dynamic random access memory (DRAM) such as synchronous DRAM (SDRAM), double data rate (DDR SDRAM), or DRAM (RDRAM), etc.), a static memory 1006 (e.g., flash memory, static random access memory (SRAM), etc.), and a data storage device 1018, which communicate with each other via a bus 1040.

Processor (processing device) 1002 represents one or more general-purpose processing devices such as a microprocessor, central processing unit, or the like. More particularly, the processor 1002 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 can also be one or more special-purpose processing devices such as an application specific integrated circuit (ASIC), a field programmable gate array (FPGA), a digital signal processor (DSP), network processor, or the like. The processor 1002 is configured to execute instructions 1005 for performing the operations discussed herein.

The computer system 1000 can further include a network interface device 1008. The computer system 1000 also can include a video display unit 1010 (e.g., a liquid crystal display (LCD) or a cathode ray tube (CRT)), an input device 1012 (e.g., a keyboard, and alphanumeric keyboard, a motion sensing input device, touch screen), a cursor control device 1014 (e.g., a mouse), and a signal generation device 1020 (e.g., a speaker).

The data storage device 1018 can include a non-transitory machine-readable storage medium 1024 (also computer-readable storage medium) on which is stored one or more sets of instructions 1005 embodying any one or more of the methodologies or functions described herein. The instructions can also reside, completely or at least partially, within the main memory 1004 and/or within the processor 1002 during execution thereof by the computer system 1000, the main memory 1004 and the processor 1002 also constituting machine-readable storage media. The instructions can further be transmitted or received over a network 1030 via the network interface device 1008.

In one implementation, the instructions 1005 include instructions for providing fine-grained version histories of electronic documents at a platform. While the computer-readable storage medium 1024 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
obtaining summarization data pertaining to content of one or more electronic messages associated with a first user of a platform;
providing a first audio signal reflecting the obtained summarization data for presentation to the first user via a client device associated with the first user;
receiving a second audio signal comprising a verbal response provided by the first user to the one or more electronic messages via the client device;
generating, based on the verbal response of the second audio signal, an additional electronic message comprising a textual response to the one or more electronic messages; and
transmitting the additional electronic message for presentation to one or more second users of the platform.

2. The method of claim 1, wherein obtaining the summarization data comprises:
providing, as an input to an AI model trained to perform a plurality of tasks pertaining to electronic documents of the platform, the one or more electronic messages and a prompt instructing the AI model to generate the summarization data based on the content of the one or more electronic messages; and
obtaining one or more outputs of the AI model, the one or more outputs comprising the summarization data.

3. The method of claim 2, wherein generating the additional electronic message comprising the textual response comprises:
providing, as an additional input to the AI model, audio data associated with the second audio signal and an additional prompt instructing the AI model to generate the additional electronic message comprising the textual response to the one or more electronic messages; and
obtaining one or more additional outputs of the AI model, the one or more additional outputs comprising the generated additional electronic message.

4. The method of claim 3, wherein the audio data comprises at least one of the second audio signal or textual data representing the verbal response of the second audio signal.

5. The method of claim 3, wherein at least one of the prompt or the additional prompt further comprises additional data associated with at least one of the first user or the one or more second users, wherein the additional data comprises at least one of:
one or more calendar entries of a calendar associated with the at least one of the first user or the one or more second users,
an indication of one or more electronic documents associated with the at least one of the first user or the one or more second users,
an indication of one or more prior electronic messages between the first user and the one or more second users,
an indication of one or more prior electronic messages between the first user and one or more third users of the platform, or
an indication of one or more user preferences associated with the first user.

6. The method of claim 1, further comprising:
identifying a first electronic message directed to the first user of the platform from the one or more second users; and
determining that content of the first electronic message is associated with content of a second electronic message directed to the first user of the platform from the one or more second users,
wherein the summarization data pertains to the content of the first electronic message and the second electronic message.

7. The method of claim 1, wherein the one or more electronic messages comprise at least one of:
an electronic mail (e-mail) message,
a chat message, or
a comment associated with one or more electronic documents.

8. A system comprising:
a memory; and
a set of one or more processing devices coupled to the memory, wherein the set of one or more processing devices is to perform operations comprising:
obtaining summarization data pertaining to content of one or more electronic messages associated with a first user of a platform;
providing a first audio signal reflecting the obtained summarization data for presentation to the first user via a client device associated with the first user;
receiving a second audio signal comprising a verbal response provided by the first user to the one or more electronic messages via the client device;
generating, based on the verbal response of the second audio signal, an additional electronic message comprising a textual response to the one or more electronic messages; and
transmitting the additional electronic message for presentation to one or more second users of the platform.

9. The system of claim 8, wherein obtaining the summarization data comprises:
providing, as an input to an AI model trained to perform a plurality of tasks pertaining to electronic documents of the platform, the one or more electronic messages and a prompt instructing the AI model to generate the summarization data based on the content of the one or more electronic messages; and
obtaining one or more outputs of the AI model, the one or more outputs comprising the summarization data.

10. The system of claim 9, wherein generating the additional electronic message comprising the textual response comprises:
providing, as an additional input to the AI model, audio data associated with the second audio signal and an additional prompt instructing the AI model to generate the additional electronic message comprising the textual response to the one or more electronic messages; and
obtaining one or more additional outputs of the AI model, the one or more additional outputs comprising the generated additional electronic message.

11. The system of claim 10, wherein the audio data comprises at least one of the second audio signal or textual data representing the verbal response of the second audio signal.

12. The system of claim 10, wherein at least one of the prompt or the additional prompt further comprises additional data associated with at least one of the first user or the one or more second users, wherein the additional data comprises at least one of:
one or more calendar entries of a calendar associated with the at least one of the first user or the one or more second users,
an indication of one or more electronic documents associated with the at least one of the first user or the one or more second users,
an indication of one or more prior electronic messages between the first user and the one or more second users,
an indication of one or more prior electronic messages between the first user and one or more third users of the platform, or
an indication of one or more user preferences associated with the first user.

13. The system of claim 8, wherein the operations further comprise:
identifying a first electronic message directed to the first user of the platform from the one or more second users; and
determining that content of the first electronic message is associated with content of a second electronic message directed to the first user of the platform from the one or more second users,
wherein the summarization data pertains to the content of the first electronic message and the second electronic message.

14. A non-transitory computer readable storage medium comprising instructions that, when executed by a processing device, cause the processing device to perform operations comprising:
obtaining summarization data pertaining to content of one or more electronic messages associated with a first user of a platform;
providing a first audio signal reflecting the obtained summarization data for presentation to the first user via a client device associated with the first user;
receiving a second audio signal comprising a verbal response provided by the first user to the one or more electronic messages via the client device;
generating, based on the verbal response of the second audio signal, an additional electronic message comprising a textual response to the one or more electronic messages; and
transmitting the additional electronic message for presentation to one or more second users of the platform.

15. The non-transitory computer readable storage medium of claim 14, wherein obtaining the summarization data comprises:
providing, as an input to an AI model trained to perform a plurality of tasks pertaining to electronic documents of the platform, the one or more electronic messages and a prompt instructing the AI model to generate the summarization data based on the content of the one or more electronic messages; and
obtaining one or more outputs of the AI model, the one or more outputs comprising the summarization data.

16. The non-transitory computer readable storage medium of claim 15, wherein generating the additional electronic message comprising the textual response comprises:
providing, as an additional input to the AI model, audio data associated with the second audio signal and an additional prompt instructing the AI model to generate the additional electronic message comprising the textual response to the one or more electronic messages; and
obtaining one or more additional outputs of the AI model, the one or more additional outputs comprising the generated additional electronic message.

17. The non-transitory computer readable storage medium of claim 16, wherein the audio data comprises at least one of the second audio signal or textual data representing the verbal response of the second audio signal.

18. The non-transitory computer readable storage medium of claim 16, wherein at least one of the prompt or the additional prompt further comprises additional data associated with at least one of the first user or the one or more second users, wherein the additional data comprises at least one of:
one or more calendar entries of a calendar associated with the at least one of the first user or the one or more second users,
an indication of one or more electronic documents associated with the at least one of the first user or the one or more second users,
an indication of one or more prior electronic messages between the first user and the one or more second users,
an indication of one or more prior electronic messages between the first user and one or more third users of the platform, or
an indication of one or more user preferences associated with the first user.

19. The non-transitory computer readable storage medium of claim 14, wherein the operations further comprise:
identifying a first electronic message directed to the first user of the platform from the one or more second users; and
determining that content of the first electronic message is associated with content of a second electronic message directed to the first user of the platform from the one or more second users,
wherein the summarization data pertains to the content of the first electronic message and the second electronic message.

20. The non-transitory computer readable storage medium of claim 14, wherein the one or more electronic messages comprise at least one of:
an electronic mail (e-mail) message,
a chat message, or
a comment associated with one or more electronic documents.
